(19) United States
(12) Patent Application Publication
(10) Pub. No.: US 2007/0168187 A1
(43) Pub. Date: Jul. 19, 2007

(54) Real time voice analysis and method for providing speech therapy

(75) Inventors: Samuel G. Fletcher, Springville, UT (US); Benjamin Faber, Spanish Fork, UT (US)

Correspondence Address: MESCHKOW & GRESHAM, P.L.C., 5727 NORTH SEVENTH STREET, SUITE 409, PHOENIX, AZ, 85014, US

(73) Assignee: Samuel G. Fletcher

(21) Appl. No.: 11/332,628

(22) Filed: Jan. 13, 2006

(51) Int. Cl. G10L 19/06

(52) U.S. Cl. 704/209

(57) ABSTRACT

A method (196) for providing speech therapy to a learner (30) utilizes a formant estimation and visualization process (28) executable on a computing system (26). The method (196) calls for receiving a speech signal (35) from the learner (30) at an audio input (34) of the computing system (26) and estimating first and second formants (136, 138) of the speech signal (35). A target (94) is incorporated into a vowel chart (70) on a display (38) of the computing system (26). The target (70) characterizes an ideal pronunciation of the speech signal (35). A data element (134) of a relationship between the first and second formants (136, 138) is incorporated into the vowel chart (76) on the display (38). The data element (134) is compared with the target (70) to visualize an accuracy of the speech signal (35) relative to the ideal pronunciation of the speech signal (35).

### TECHNICAL FIELD OF THE INVENTION

The present invention relates to the field of speech therapy. More specifically, the present invention relates to speech analysis and visualization feedback for the hearing and/or speech impaired and in new language sound learning.

### BACKGROUND OF THE INVENTION

Speech can be described as an act of producing sounds using vibrations at the vocal folds, resonances generated as sounds traversing the vocal tract, and articulation to mold the phonetic stream into phonic gestures that result in vowels and consonants in different words. Speech is usually perceived through hearing and learned through trial and error repetition of sounds and words that belong to the speaker's native language. Second language learning can be more difficult because sounds, particularly the vowels from the native language inhibit new sound mastery.

By definition, hearing impaired individuals are those persons with any degree of hearing loss that has an impact on their activities of daily living or who require special assistance or intervention due to the inability to hear the speech related sound frequencies and intensities. The term “deaf” refers to a person who has a permanent and profound loss of hearing in both ears and an auditory threshold of more than ninety decibels. Thus, the task of learning to speak can be difficult for any person with impaired hearing, and extremely difficult for the deaf.

Sign languages have developed that use manual communication instead of sound to convey meaning. This enables the deaf or severly hearing impaired person to express thoughts fluently. While sign language is an effective alternative communication tool for those who understand the manual combination of hand shapes, orientation and movement of the hands, arms or body, and facial expressions, the majority of the general population cannot understand this manual language. Therefore, outside of a particular deaf community, a deaf person may be required to communicate with the hearing population through an interpreter.

To circumvent the manual communication problem, deaf persons may undergo speech therapy to learn to communicate without acoustic feedback. This entails watching the teacher's lips and using glimpses of tongue movements to arrive at recognizable sounds then try to use these sounds in real life vocal communication settings. This repetitive, trial and error, procedure is time consuming, too often unsuccessful, tedious, and frustrating to both the learner and the teacher. In addition, the resulting still limited vocal skills are reflected in the typical high school deaf graduate by difficult-to-understand speech and in reading at a fourth grade level.

Early methods of in vivo speech investigation were restricted to what could be seen (e.g., movement of the lips and jaw), felt (e.g., vibration of the larynx, gross tongue position), or learned from introspection of articulator positions during speech production. Much was proven to be surmised correctly when these observations were combined with those from anatomical and mechanical studies of cadavers. Attempts to understand speech production then graduated to simple techniques such as dusting the palate with corn starch, producing a sound, sketching the pattern of starch removal from the palate, and linking that pattern to tongue postures inside the mouth. The use of such procedures was limited, however, due to the inability to visualize actions that led to the response. Attempts to translate actions into visual patterns led to emergence of the sound spectrograph that converts sound waves into visual displays of the sound spectrum. The sound spectrum can then be shown on an oscilloscope, cathode ray tube, or a like instrument. Through the use of visual feedback techniques provided by the spectrograph, the sound spectrograph became a powerful speech science tool, and attempts were made to enhance conventional speech using the sound spectrograph. Unfortunately, the complex spectrographic displays were difficult to interpret and extremely difficult to use in speech therapy.

Devices, such as the electronic palatograph developed in the mid-nineteen hundreds, provided more rigorous assessment of speech articulation, but were stymied by speaker-to-speaker variations in contact sensing locations and inability to translate phonetic data into standardized measures and quantitative descriptions of speech similarities and variations in order to define phonetic gesture normality and abnormailty accurately. Development of the palatometer partially overcame the limitations of prior art electronic palatographs. The palatometer includes a mouthpiece contained in the user's mouth. The mouthpiece resembles an orthodontic retainer having numerous sensors mounted thereon. The sensors are connected via a thin strip of wires to a box which collects and sends data to a computer. The computer's screen displays two pictures—one of a simulated mouth of a “normal speaker” and one of a simulated mouth in which the locations of the sensors are represented as dots. As the user pronounces a sound, the tongue touches specific sensors, which causes corresponding dots to light up on the simulated mouth displayed on the computer. The user may learn to speak by reproducing on the simulated mouth the patterns presented on the display of the “normal speaker.”

While a palatometer system shows promise as a tool for teaching verbal communication to the hearing impaired, such a system is costly since each user must have a customized mouthpiece to which he or she must adapt. Moreover, this customized mouthpiece tends to distort the sounds produced to some variable degree. In addition, since a palatometer system entails specialized hardware, use of such a system may be limited to speech therapy sessions within an office or place of business. As such, the learner may not have sufficient opportunity for repetition of the learning exercises.

Learning to successfully master vowel sounds is an important step in speech and language learning. Unfortunately, however, learning to properly pronounce vowels can be difficult because there aren't clear boundaries between vowels. That is, one vowel sound glides into the next. Vowel diphthongs are particularly difficult to master for those who are deaf because diphthongs require blending two consecutive contrasting vowels smoothly together.

Studies of speech pathologies by those who are deaf have shown their vowels to differ sharply from those produced by persons with normal hearing. In general, their tongue postures are centered around a neutral vowel position with comparatively little vowel-to-vowel spatial variation. These observations point to under utilization of oral space. Inappropriate tongue postures and movements within that space evidence unawareness of the sound production process. Slowly produced, prolonged, “schwa-like” vowels and abnormally long and inappropriate pauses reflect disruptions in timing control. Interjection of extra sounds into words, failure to differentiate stressed and unstressed syllables, excessive or insufficient vocal frequency variation, and low intelligibility all indicated unawareness of basic phonetic rules.

The International Phonetic Alphabet (IPA) is a system of phonetic notation devised by linguists to accurately and uniquely represent each of the wide variety of sounds used in spoken human language. It is intended as a notational standard for the phonemic and phonetic representation of all spoken languages. The IPA was generated based on the way sounds are pronounced (i.e. manner of articulation) and where in the mouth or throat they are pronounced (their place of articulation). With particular regard to vowels, the International Phonetic Alphabet includes a vowel diagram.

FIG. 1 shows a chart of the International Phonetic Alphabet (IPA) vowel diagram 20. In IPA vowel diagram 20, vowel symbols 22 representing vowels are arranged according to the position of the learner's tongue within the mouth from front to back and high to low within the mouth. The oral space. can be bounded phonetically by high-front vowel /i/, as in heed, low-front vowel /æ/, as in had, high-back vowel /u/, as in who'd, and low-back vowel /a/, as in hod. A “high” position is referred to as “close,” meaning the tongue is as close as possible to the roof of the mouth. Whereas, a “low” position is referred to as “open,” meaning the tongue is drawn toward the floor of the mouth. A “front” position means placement of the tongue in a forward position, and a “back” position means pulling the tongue back as much as possible without blocking the phonic stream flow into the oral cavity.

Additionally, positions in IPA vowel diagram 20 are occupied by pairs of vowel symbols 22. These pairs of vowel symbols 22 differ in-terms of roundedness, with the one on the left of a point 24 being an unrounded vowel, while the one on the right of point 24 is a rounded vowel. Roundedness refers to the shape of the lips when pronouncing a vowel. For example, /u/, as in who'd, is rounded, but /i/, as in heed, is not.

The information provided in IPA vowel chart 20 may be a useful tool for understanding the necessary mouth and tongue positions for reproducing vowel sounds when teaching a hearing impaired individual, or in new language sound learning, regardless of the particular language being used. Unfortunately, however, IPA vowel chart 20 does not provide feedback to the student as to the success of their own utterances.

Vowel sounds are also differentiated acoustically through contrasting oral cavity resonances generated by tongue positions and by varying widths of a channel formed down the center of the tongue through which the phonic stream flows. Each cavity acts as a band-pass filter that transmits certain resonances and attenuates others. The resonances may be identified scientifically by noise concentrations called “formants” in sound spectrographic displays. Thus, formants are the distinguishing or meaningful frequency components of human speech and singing. The lower two formants are associated with high and low (F1) and forward and backward (F2) tongue postures within the oral cavity, while the third and fourth formants (F3 and F4) reflect a speaker's voice qualities.

In theory, the information that humans require to distinguish between vowels can be represented purely quantitatively by the frequency content of the vowel sounds, i.e., their formants. It is understood that auditory differentiation between vowel sounds may be dependent upon the frequency placement of the first two of these energy concentrations, i.e., the first two formants in the vocal spectrum. However, accurate and consistent formant analysis has been elusive due to many variables including gender, age, background noise, unvoiced speech, and so forth.

A related and compelling problem lies with the presentation of formant information in a manner that is both timely and understandable to a wide range of learners (both hearing impaired and new language learners, adults and children). The formant information must also be presented in a manner that can be readily interpreted in accordance with a standard, such as the IPA vowel diagram, by speech pathologists and instructors who are helping the learners use the information to achieve normal vowel production and pronunciation.

### SUMMARY OF THE INVENTION

Accordingly, it is an advantage of the present invention that a method of providing speech therapy using a computing system executing voice analysis and visualization code is provided.

It is another advantage of the present invention that the methodology and code enhance the learning of vowel sounds.

Another advantage of the present invention is that the methodology and code provide visualization of speech signals and a determination of accuracy of the speech signals.

Yet another advantage of the present invention is that the voice analysis and visualization code is readily portable for a learner's independent study.

The above and other advantages of the present invention are carried out in one form by a method for providing speech therapy to a learner. The method calls for receiving a speech signal from the learner at an audio input of a computing system and estimating, at the computing system, a first formant and a second formant of the speech signal. A target incorporated into a chart on a display of the computing system is presented. The target characterizes an ideal pronunciation of the speech signal. The method further calls for displaying a data element of a relationship between the first formant and the second formant incorporated into the chart on the display. The data element is compared with the target to visualize an accuracy of the speech signal relative to the ideal pronunciation of the speech signal.

The above and other advantages of the present invention are carried out in another form by a computer-readable storage medium containing executable code for instructing a processor to analyze a speech signal produced by a learner, the processor being in communication with an audio input and a display. The executable code instructs the processor to perform operations that include enabling receipt of the speech signal from the audio input and estimating a first formant and a second formant of the speech signal in real-time in conjunction with the receiving operation. A target is presented on the display characterizing an ideal pronunciation of the speech signal by incorporating the target into a two dimensional coordinate graph. A data element of a relationship between the first formant and the second formant is displayed by plotting the data element as an x-y pair of the first and second formants in the two dimensional coordinate graph for comparison of the data element with the target to visualize an accuracy of the speech signal relative to the ideal pronunciation of the speech signal.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a chart of the International Phonetic Alphabet (IPA) vowel diagram;

FIG. 2 shows a block diagram of a computing system for executing a formant analysis and visualization process utilized by a learner undergoing speech therapy;

FIG. 3 shows a flowchart of the formant analysis and visualization process;

FIG. 4 shows a screen shot image of a main window presented in response to execution of the formant visualization code;

FIG. 5 shows a partial screen shot image of an age/gender drop-down menu;

FIG. 6 shows a partial screen shot image of a vowel target drop-down menu;

FIG. 7 shows a screen shot image of a vowel chart presenting a plurality of vowel targets in accordance with a preferred embodiment of the present invention;

FIG. 8 shows a screen shot image of a time waveform chart of a speech signal produced by a learner and generated in response to the execution of the formant visualization code;

FIG. 9 shows a screen shot image of a vowel chart presenting vowel targets and a vowel path generated in response to execution of the formant analysis and visualization process;

FIG. 10 shows a screen shot image of a formant trajectory diagram generated in response to execution of the formant analysis and visualization process;

FIG. 11 shows a flowchart of a target customization process that may be performed utilizing the formant analysis and visualization process;

FIG. 12 shows a screen shot image of a modifiable vowel target table;

FIG. 13 shows a screen shot image of a vowel chart in which one of a plurality of vowel targets is being modified; and

FIG. 14 shows a flowchart of a speech therapy process that utilizes the computing system of FIG. 1 executing the formant analysis and visualization process.

### DETAILED DESCRIPTION OF THE PREFERRED EMBODIMENTS

The present invention entails formant analysis and visualization code executable on a conventional computing system and methodology for providing speech therapy to a learner utilizing the computing system. The invention focuses on formants which are the acoustically distinguishing components in spoken vowels. The present invention overcomes the problems of prior art speech therapy techniques and devices through analysis and visual displays that can isolate and demonstrate deviations in the frequency components of abnormal vowels.

The learner may be a child or adult of either gender, and may be hearing impaired or have another physical and/or cognitive deficit resulting in difficulty with verbal communication. The term “hearing impaired” used herein refers to those individuals with any degree of loss of hearing, from minor to those with severe or profound hearing loss. Persons with impaired hearing will be used to illustrate the advantages of the present invention. However, it should be evident to those familiar with the state of the art regarding speech disorders of the deaf, that the present invention may be useful in the examination and treatment of many other speech pathologies. In addition, the present invention may be utilized by an individual in new language sound learning.

The present invention relates to speech assessment and treatment using first and second (F1/F2) spectrographic formant analysis to visualize, evaluate, and guide change in tongue positions and movements during normal and abnormal vowel production. These formants can be tracked over a number of repetitions of a speech signal to provide feedback to the learner as to their ability to reliably reproduce the speech signal. The present invention may be utilized alone or as an adjunct to traditional and developing speech therapy methodologies.

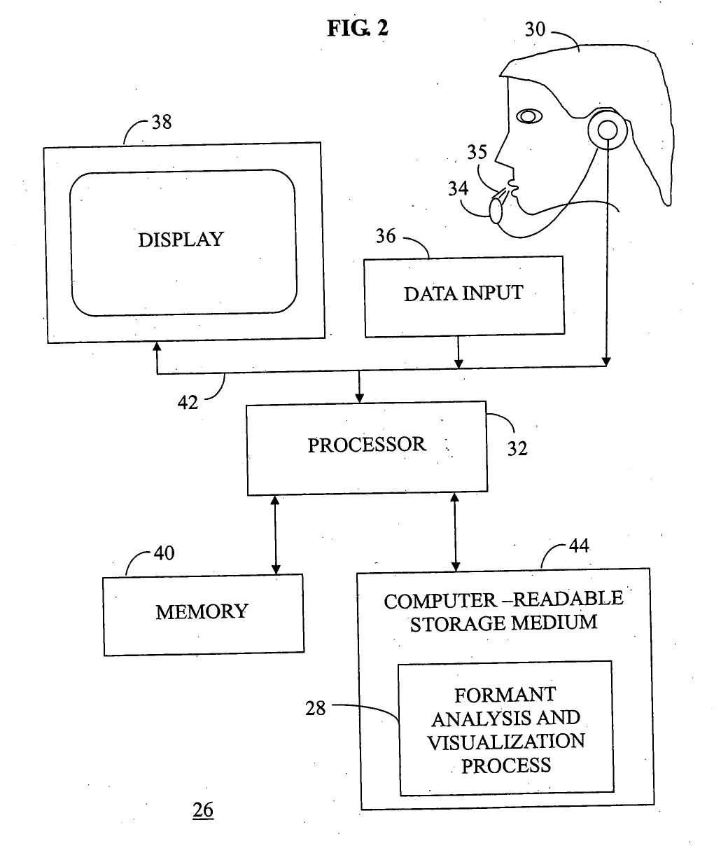

FIG. 2 shows a simplified block diagram of a computing system 26 for executing a formant analysis and visualization process 28 utilized by a learner 30 undergoing speech. therapy. Computing system 26 includes a processor 32 on which the methods according to the invention can be practiced. Processor 32 is in communication with an audio input 34, a data input 36, a display 38, and a memory 40 for storing data files (discussed below) generated in response to the execution of formant analysis and visualization process 28. These elements are interconnected by a bus structure 42.

Audio input 34 is preferably a headset microphone receiving a speech signal 35 from learner 30. The headset microphone provides mobility, comfort, high sound quality, isolation from extraneous sound sources, and high gain-before-feedback. Data input 36 can encompass a keyboard, mouse, pointing device, and the like for user-provided input to processor 32. Display 38 provides output from processor 32 in response to execution of formant analysis and visualization process 28. Computing system 26 can also include network connections, modems, or other devices used for communications with other computer systems or devices.

Computing system 26 further includes a computer-readable storage medium 44. Computer-readable storage medium 44 may be a magnetic disk, compact disk, or any other volatile or non-volatile mass storage system readable by processor 32. Formant analysis and visualization process 28 is executable code recorded on computer-readable storage medium 44 for instructing processor 32 to analyze a speech signal (discussed below) and subsequently present the results of the analysis on display 38 for visualization by learner 30.

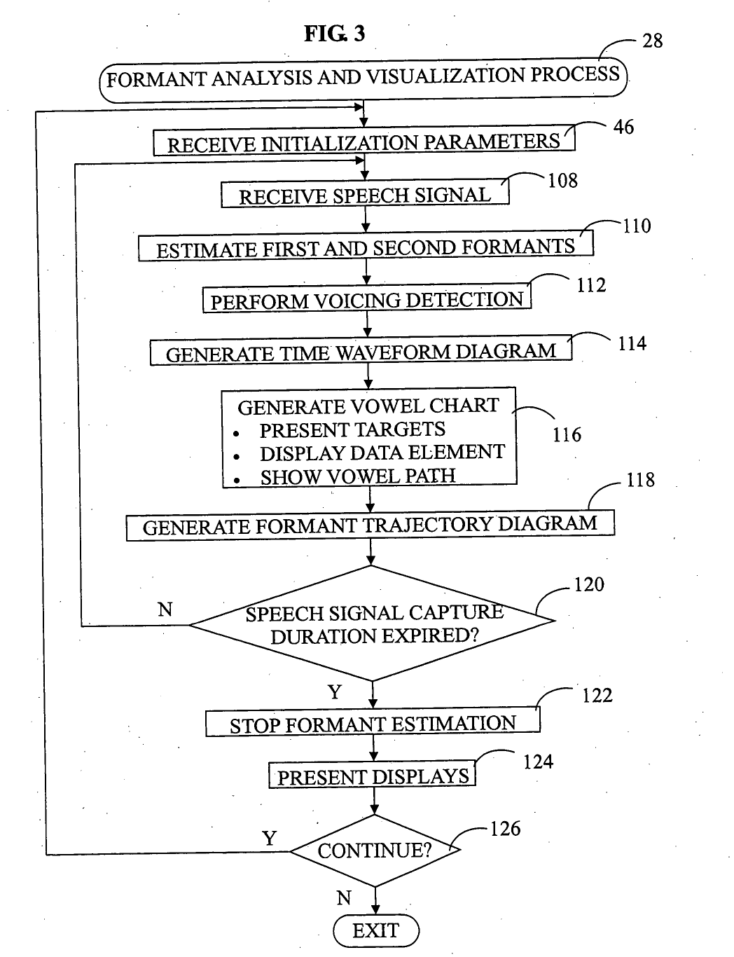

FIG. 3 shows a flowchart of formant analysis and visualization process 28. Process 28 is executed to receive and analyze speech signals and visualize those speech signals relative to targets characterizing ideal pronunciations of those speech signals. Process 28 is particularly suited for incorporation into speech therapy methodologies for learning to accurately articulate vowels sounds.

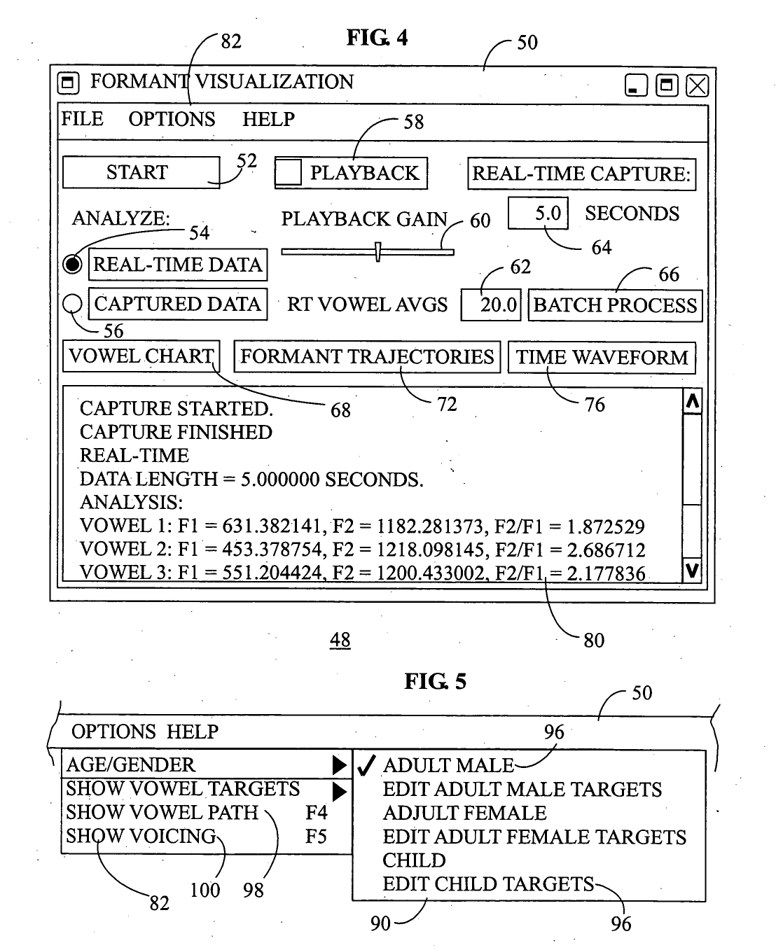

Formant analysis and visualization process 28 begins with a task 46. At task 46, initialization parameters are received. Referring to FIG. 4 in connection with task 46, FIG. 4 shows a screen shot image 48 of a main window 50 presented on display 38 (FIG. 2) in response to execution of formant analysis and visualization process 28. Main window 50 is the primary opening view of process 28, and includes a number of user fields, referred to as buttons, for determining the behavior of process 28 and controlling its execution.

Main window 50 includes a START button 52 that a user can select to initiate data analysis and visualization. A REAL-TIME DATA button 54 may be selected to cause process 28 to obtain speech signal 35 for analysis from audio input 34 (FIG. 20). Speech signal 35 will subsequently be analyzed and displayed in various display windows in real-time. A CAPTURED DATA button 56 to cause process 28 to analyze previously recorded signals stored, for example, in memory 40 (FIG. 2). A PLAYBACK button 58 affects the behavior of process 28 when the selected analysis option is captured data, and a PLAYBACK GAIN 60 slider affects the volume level of the audio when it is played back.

An RT VOWEL AVGS text box 62 allows a user to select a number of formant estimates to average within a segment of speech signal 35 (FIG. 2). Process 28 employs exponential averaging of the first and second formant estimates in order to smooth a real-time display of an intersection of the first and second formants in a vowel chart (shown, for example, in FIG. 7). A larger number in text box 62 will result in more smoothing for easier visualization of the vowel chart as it is updated.

A REAL-TIME CAPTURE text box 64 allows a user to enter a duration of speech signal 35 (FIG. 2) to be captured by process 28 when REAL-TIME DATA button 54 is selected. BATCH PROCESS button 66 allows multiple files to be selected for simultaneous processing, the results-of which are automatically saved to text files within the same directory as the original speech data files.

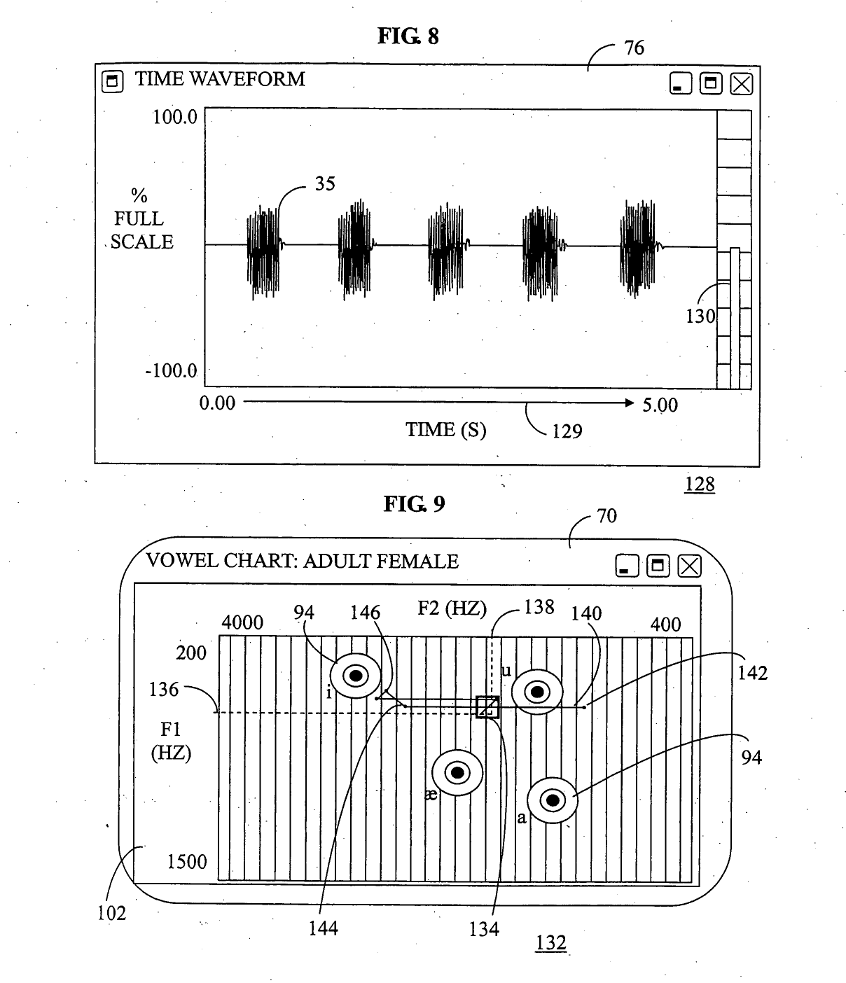

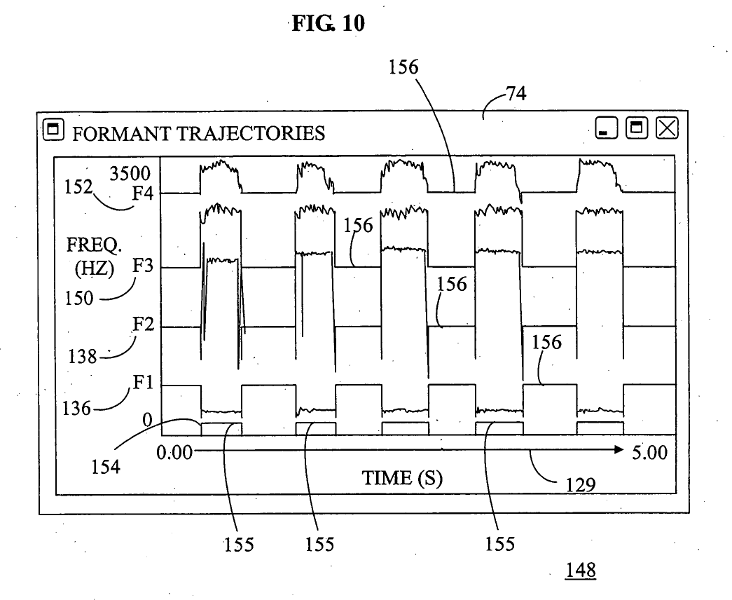

Especially pertinent to the present invention, main window includes a VOWEL CHART button 68 for showing and hiding a vowel chart 70 (shown in FIG. 7), a FORMANT TRAJECTORIES button 72 for showing and hiding a formant trajectories diagram 74 (shown in FIG. 10), and a TIME WAVEFORM button 74 for showing and hiding a time waveform diagram 76 (shown in FIG. 8). A text box 80 displays various information about, for example, status of the program and data collection, elapsed time, analysis parameters, and so forth.

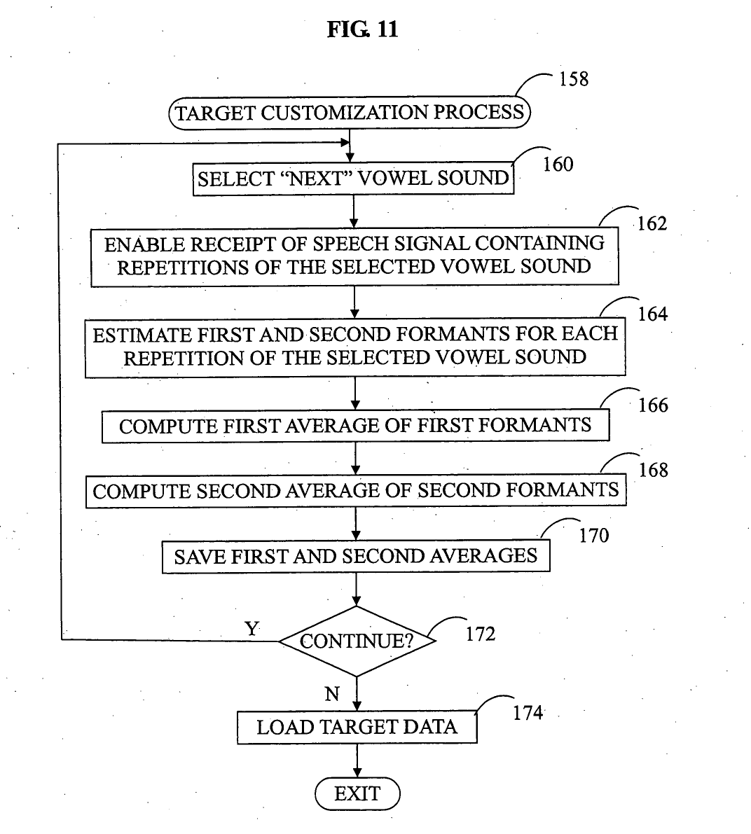

Initialization parameters further include age/gender selection, target presentation selection, vowel path display selection, and voice detection all of which are discussed in connection with FIG. 5. Initialization parameters that entail optional target customization are discussed in connection with FIGS. 11-13. The initialization parameters can be readily selected by a user, either the learner or an instructor, via an OPTIONS menu 82 presented in main window 50.

Referring to FIG. 5 in conjunction with initialization task 46 (FIG. 3) of formant analysis and visualization process 28, FIG. 5 shows a partial screen shot image 84 of an AGE/GENDER drop-down menu 86 within OPTIONS menu 82 presented in main window 50 in response to execution of formant visualization and analysis process 28. Formant analysis techniques are greatly influenced by the gender and age of the learner. In particular, the natural variations of vocal tract length and pitch between the voices of men, women, and children result in differing formant frequency bands for men, women, and children. Therefore, formant estimation calls for knowledge of the gender and age of learner 30 (FIG. 2) to avoid gender and age related inaccuracies in formant estimation.

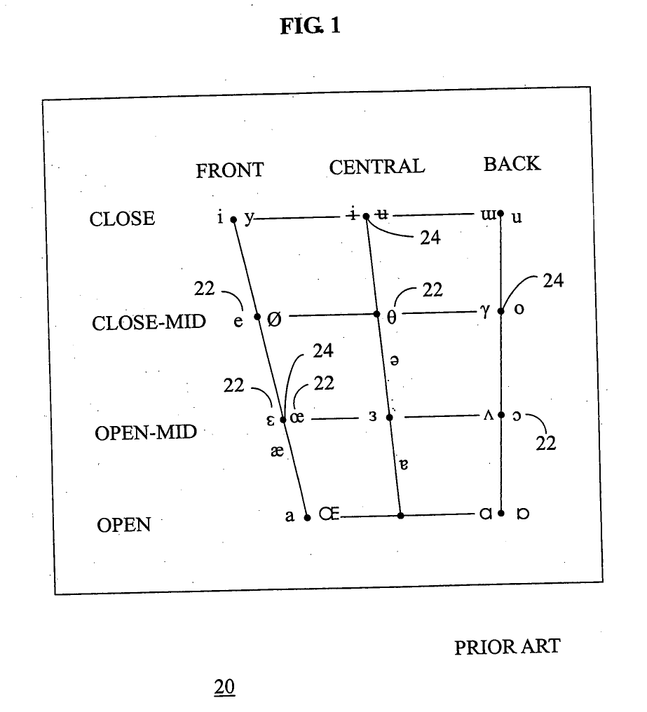

Accordingly, the user has the choice of selecting ADULT MALE, ADULT FEMALE, and CHILD in AGE/GENDER drop-down menu 86 to determine where vowel targets (discussed below) in vowel chart 70 (FIG. 1) are located. In addition, the user has the choice of modifying a location of vowel targets in vowel chart 70 (FIG. 7) by optionally selecting EDIT ADULT MALE TARGETS, EDIT ADULT FEMALE-TARGETS, and EDIT CHILD TARGETS. Target editing will be discussed in. detail in connection with FIGS. 11-13.

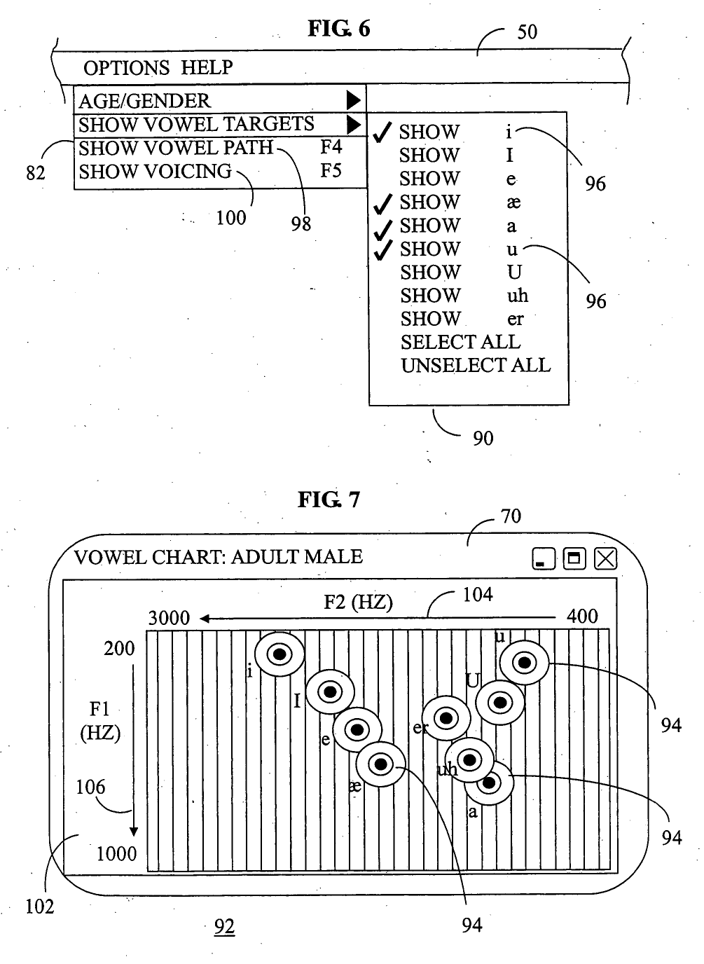

Referring to FIGS. 6-7 in conjunction with initialization task 46 (FIG. 3) of formant analysis and visualization process 28, FIG. 6 shows a partial screen shot image 88 of a vowel target drop-down menu 90 within OPTIONS menu 82 presented in main window 50 in response to execution of formant visualization and analysis process 28. FIG. 7 shows a screen shot image 92 of vowel chart 70 presenting a plurality of vowel targets 94 in accordance with a preferred embodiment of the present invention.

Vowel target drop-down menu 90 enables a user to select a number of vowel sounds 96 that he or she would like to present in vowel chart 70 as vowel targets 94. Vowel sounds 96 are generally correlated with vowel symbols 22 (FIG. 1) of IPA vowel diagram 20 (FIG. 1), and each of vowel targets 94 characterizes an intersection, or vowel point, between first and second formants of an ideal pronunciation of a particular one of vowel sounds 96 for which it represents. In an exemplary embodiment, each of vowel targets 94 is presented as concentric circles centered at a predetermined location in vowel chart 70. The concentric circles demarcate a region at which the corresponding one of vowel sounds 96 may be reproduced.

The oral spatial relationships across different vowels may be meaningfully schematized via vowel chart 70, in the form of a “quadrilateral vowel diagram.” In vowel chart 70, the previously discussed vowels that phonetically bound the oral space (i.e., vowel sounds 96 labeled /i/, /æ/, /u/, /a/) can be thought of as “point vowels” because they are located at each corner of vowel chart 70. The other vowel sounds 96 represented at phonetically labeled vowel targets 94 are distributed at non-overlapping intervals within and around the quadrilateral framework of vowel chart 70. Abnormalities can be evidenced by vowel targets 94 located at deviant, often overlapping sites within and around vowel chart 70. That is, when data is collected from a sizeable number of speakers and the individual utterances are represented in scatter plots, the outliers beyond one to two standard deviations from the mean of the vowels from all speakers are assumed to reflect uncharacteristic vowel production can be labeled as abnormal.

OPTIONS menu 82 further includes a SHOW VOWEL PATH menu item 98 that causes process 82 to trace a path on vowel chart 70 of updates in vowel chart 70. In addition, OPTIONS menu 82 includes a SHOW VOICING menu item 100. Selection of SHOW VOICING menu item 100 will cause process 28 to identify which portions of speech signal 35 (FIG. 2) are voiced and which portions of speech signal are unvoiced. Generally, sounds produced due to a periodic glottal source are known as voiced sounds, and sounds produced otherwise are known as unvoiced sounds. Vowels are voiced sounds. Voiced speech has more low-frequency energy and is quasi-periodic. In contrast, unvoiced speech has more high-frequency energy, is noisy in nature and does not require the vibration of vocal cords. Due to its noisy nature, unvoiced speech does not have formants. Therefore, any formant estimation performed for the regions of unvoiced speech would be inaccurate. When SHOW VOICING menu item 100 is selected, process 28 will disregard any formants estimated during those episodes of unvoiced speech.

Vowel chart 70 illustrated in screen shot image 92 is a two dimensional coordinate graph 102 in which a first number scale 104 for the second formant (F2) is arranged along a horizontal, or x-, axis of graph 102, and a second number scale 106 for the first formant (F1) is arranged along a vertical, or y-, axis of graph 102. Moreover, first number scale 104 is arranged in descending order from leftward to rightward (i.e., opposite from that of a conventional two dimensional coordinate graph). Similarly, second number scale 106 is arranged in ascending order from upward to downward (again opposite from that of a conventional two dimensional coordinate graph).

The arrangement of vowel chart 70 enables the placement of vowel targets 94 at locations on vowel chart 70 similar to that of a typically utilized vowel diagram, such as IPA vowel diagram 20 (FIG. 1). Consequently, vowel chart 70 is correlated with a vowel diagram so that learner (FIG. 2) can comprehend the tongue and mouth positions needed (front/back, close/open, and rounded/unrounded) to articulate a particular vowel.

With reference back to formant analysis and visualization process 28 (FIG. 3), initialization task 46 (FIG. 3) allows the user to manipulate the operation of process 28 by setting initialization parameters that influence speech signal collection, formant estimation, display, and the like. Following task 46, process 28 is ready to collect real-time speech signals or process pre-recorded speech files at the user's discretion. In accordance with a preferred embodiment of the present invention, process 28 is configured to perform real-time data collection.

Following task 46, process 28 awaits activation of START button 52 (FIG. 4) of main window 50 (FIG. 4). At a detection of actuation of START button 52, process 28 proceeds to a task-108. Task 108 enables receipt of speech signal 35 (FIG. 2) from audio input 34 (FIG. 2).

A task 110 is executed concurrent with receiving task 108. At task 110, processor 32 (FIG. 2) estimates at least first and second formants of speech signal 35. In an exemplary embodiment, the present invention employs an inverse-filter control algorithm for real-time estimation of instantaneous formant frequencies. One such algorithm is described in an article entitled “Formant Estimation Method Using Inverse-Filter Control”, by Akira Watanabe, IEEE Transactions on Speech and Audio Processing, Vol. 9, No. 4, May 2001.

Estimation of formant frequencies based on inverse-filter control can accurately yield the lowest four to six formants. In addition, estimation of formant frequencies based on inverse-filter control directly estimates resonant frequencies of a vocal tract yielding fewer gross errors when estimating formants in real speech relative to other formant frequency estimation techniques.

Although an inverse-filter control algorithm is preferred, those skilled in the art will recognize that other current and upcoming formant frequency estimation algorithms, such as analysis-by-synthesis and linear predictive coding methodologies, may alternatively be employed.

A task 112 is performed in conjunction with task 110 when SHOW VOICING menu item 100 (FIG. 6) is selected. At task 112, when SHOW VOICING menu item 100 is selected, voicing detection methodology will detect voiced and unvoiced sounds in speech signal 35 (FIG. 2). During voiced portions of speech signal 35, formant trajectories will reflect the appropriate formant estimations. During unvoiced portions of speech signal 35, formant estimation calculations are invalid. Therefore, task 112 causes formant estimations computed during unvoiced portions of speech signal 35 to be disregarded.

In an exemplary embodiment, the present invention employs a voicing detector described in a thesis entitled “Robust Formant Tracking For Continuous Speech With Speaker Variability,” by Kamran Mustafa, pages 54-62 of a thesis submitted to the School of Graduate Studies at McMaster University, December 2003. However, those skilled in the art will recognize that other current and upcoming voicing detection methodologies may alternatively be employed.

In response to the execution of tasks 110 and 112, tasks 114, 116, and 118 are performed. At task 114, time waveform diagram 78 (FIG. 8) is generated. Similarly, vowel chart 70 including the results of formant estimation task 110 (FIG. 9) is generated at task 116, and formant trajectories diagram 74 (FIG. 10) is generated at task 118. Tasks 114, 116, and 118 are illustrated and described herein in a serial manner for simplicity of description. However, it should be understood that execution of process 28 results in the concurrent creation of vowel chart 70, formant trajectories diagram 74, and time waveform diagram 78.

Following tasks 114, 116, and 118, a query task 120 determines whether the speech signal capture duration set in REAL-TIME CAPTURE text box 64 (FIG. 4) of main window 50 (FIG. 4) has expired. When the capture duration has not expired, process 28 loops back to task 108 to continue receiving speech signal 35 and to continue formant estimation. However, when query task 120 determines that the capture duration as expired, program control proceeds to a task 122 to stop formant estimation.

Following task 122, a task 124 is performed per the user's discretion. That is, at task 124, process 28 awaits and acts upon one or more requests to view displays such as vowel chart 70, formant trajectories diagram 74, and/or time waveform diagram 78. Requests are detected by selection of one or more of VOWEL CHART button 68 (FIG. 4), FORMANT TRAJECTORIES button 72 (FIG. 4), and TIME WAVEFORM button 76 (FIG. 4). As requests are received, additional windows open revealing vowel chart 70, formant trajectories diagram 74, and/or time waveform diagram 78.

Process 28 continues with a query task 126. At query task 126, a determination is made as to whether formant analysis and visualization process 28 is to continue. Per conventional program control procedures, process 28 can remain open and operable until a conventional exit command from a conventional FILE menu of main window 50 (FIG. 4) is selected by the user. When the user selects the exit command, formant analysis and visualization process 28 exits. However, when the user does not select the exit command, process 28 loops back to task 46 to await any changes to initialization parameters and to await receipt of another speech signal 35 (FIG. 2).

Thus, through the execution of executable code corresponding to formant analysis and visualization process 28 one or more speech signals 35 (FIG. 2) can be processed in real time for the purpose of providing a visualization of voiced speech. This real-time visualization can then provide a feedback mechanism to assist learner 30 (FIG. 2) to speak properly.

FIG. 8 shows a screen shot image 128 of time waveform diagram 76 generated in response to the execution of formant analysis and visualization process 28 (FIG. 3). Time waveform diagram 76 displays the. raw speech signal 35 (FIG. 2) produced by learner (FIG. 2) over a duration 129 of speech signal capture. When formant estimation of process 28 is occurring in real-time, time waveform diagram 76 may be updated at intervals, for example, every forty milliseconds, in order to display the evolution of speech signal 35 in real-time. A peak level meter 130 is additionally presented in time waveform diagram 76. Peak level meter 130 can be utilized to monitor the peak level (i.e., loudness) of speech signal 35 to facilitate proper calibration of the input volume level from audio input 34 (FIG. 2).

In this exemplary scenario, speech signal 35 includes a number of repetitions of a sound, separated by spans of silence. Such a pattern might arise, when learner 30 (FIG. 1) repeats the same vowel sound a number of times during a single speech signal capture duration. However, those skilled in the art will recognize that speech signal 35 presented in time waveform diagram 76 can take on a large variety of periodic and/or non-periodic forms in accordance with the utterances of learner 30 (FIG. 2).

FIG. 9 shows a screen shot image 132 of vowel chart 70 generated in response to the execution of formant analysis and visualization process 28 (FIG. 3). In addition to selected vowel targets 94, vowel chart 70 displays real-time updates of the intersection between the first and second formant frequencies from speech signal 35 in two dimensional coordinate graph 102. A current data element 134, or “vowel space” estimate, in the form of a square drawn within vowel chart indicates the instantaneous first and second formant estimates. In an exemplary embodiment, current data element 134 may be centered at a position plotted in vowel chart 70 as an x-y pair of first and second formants. In particular, a first formant, F1, 136 is an ordinate of the x-y pair, and a second formant, F2, 138.

When SHOW VOWEL PATH menu item 98 (FIG. 5) is selected, vowel chart 70 will further include a trace 140 interconnecting consecutive updates to vowel chart 70. For example, a first data element 142 is marked at an onset of trace 140 and a second data element 144 is marked leftward from first data element 142, and a portion of trace 140 interconnects first and second data elements 142 and 144, respectively. Similarly, a portion of trace 140 interconnects second-data element 144 and a third data element 146.

The location of current data element 134 relative to the location of a particular one of vowel targets 94 characterizing an ideal pronunciation of the associated one of vowel sounds 96 (FIG. 6) can be compared to visualize an accuracy of speech signal 35 (FIG. 2) to its ideal pronunciation. The closer that current data element 134 gets to a particular one of vowel targets 94, the more accurately learner 30 is pronouncing that sound. Trace 140 provides instantaneous feedback to learner 30 as to how adjustments made by learner 30 to modify speech signal 35 affect its pronunciation. As such, trace 140 provides a historical perspective of repetitions of a particular one of vowel sounds 96 so that learner 30 can visualize an adjustment of his or her utterances relative to a corresponding one of vowel targets 94. Through the provision of current data element 134 and trace 140, learner 30 (FIG. 2) is provided with visual feedback as to the accuracy and repeatability of their utterances.

FIG. 10 shows a screen shot image 128 of formant trajectories diagram 74 generated in response to the execution of formant analysis and visualization process 28 (FIG. 3). Formant trajectories diagram 74 displays estimates of first formant 136 and second formant 138 over duration 129 of speech signal capture. As discussed previously, estimation of formant frequencies based on inverse-filter control can accurately yield the lowest four to six formants. Consequently, formant trajectories diagram 74 can further include estimates of at least a third formant 150 and a fourth formant 152 over duration 129. Although first and second formants 136 and 138 are typically sufficient for disambiguating vowels, third and fourth formants 150 and 152, respectively, may be useful for identifying some voiced consonants, such as nasals and/or liquids.

When SHOW VOICING menu item 100 (FIG. 4) is selected, formant analysis and visualization process 28 (FIG. 3) will disregard any formants estimated during those identified episodes of unvoiced speech. This identification can be visualized in formant trajectories diagram 74 as a voicing path 154. If speech signal 35 (FIG. 2) is voiced, voicing path 154 is drawn at approximately one hundred hertz. Therefore, voicing path 154 drawn at approximately one hundred hertz represents a voiced segment 155 of speech signal 35. However, if speech signal 35 is unvoiced, voicing path 154 is drawn at approximately zero hertz and the formant trajectories shown in formant trajectories diagram 74 will be held at default values 156.

FIG. 11 shows a flowchart of a target customization process 158 that may be performed utilizing formant analysis and visualization process 28 (FIG. 3). As mentioned briefly above, the user has the choice of modifying a location of vowel targets 94 in vowel chart 70 (FIG. 7) by optionally selecting EDIT ADULT MALE TARGETS, EDIT ADULT FEMALE TARGETS, or EDIT CHILD TARGETS from AGE/GENDER drop-down menu 86 of OPTIONS menu 82. Target location editing may be desired to generate vowel targets 94 in accordance with speech characteristics of the particular learner 30 (FIG. 2), such as pitch, loudness, clarity, and the learner's personal capability, or in accordance with speech characteristics of a particular population (gender, age, regional dialect) in which learner 30 is included.

Formant analysis and visualization process 28 (FIG. 3) can be executed as part of target customization process 158 to obtain new vowel targets 94. Target customization process 158 begins with a task 160. At task 160, a user who is most likely the speech therapist or a linguist, selects a “next” vowel sound 96 (FIG. 6) that the therapist would like pronounced. Of course, it should be understood, that during a first iteration of process 158, the “next” vowel sound 96 is a first one of the vowel sounds 96 to be analyzed at the therapist's discretion.

Next, a task 162 is performed. At task 162, the therapist enables receipt of speech signal 35 (FIG. 2) containing repetitions of the selected vowel sound 96. Receipt is enabled by selecting START button 52 (FIG. 4) in main window 50 (FIG. 4).

In response to task 162, a task 164 is performed. At task 164, processor 32 (FIG. 2) performs real-time formant estimation to obtain multiple first and second formants 136 and 138, respectively, (FIG. 10) for each repetition of the selected vowel sound 96. Tasks 162 and 164 may be repeated multiple times to obtain a plurality of first and second formants 136 and 138, respectively, for the selected vowel sound 96

Following task 164, a task 166 is performed to compute a first average of the multiple estimated first formants 136, and a task 168 is performed to compute a second average of the multiple estimated second formants 138.

A task 170 is performed following tasks 166 and 168. At task 170, the first and second averages of first and second formants 136 and 138, respectively, are saved or retained for entry into a vowel target table (discussed below).

Following task 170, a query task 172 is performed. At query task 172, a determination is made by the therapist as to whether there is another one of vowel sounds 96 (FIG. 6) that the therapist would like pronounced. When the therapist wishes to continue with the next one of vowel sounds 96, process 158 loops back to task 160 to select the next vowel sound, repeat the estimation process, and compute first and second averages of first and second formants of the next vowel sound. However, at query task 172, when there are no further vowel sounds 96, process 158 proceeds to a task 174.

At task 174, the computed first and second averages are loaded as target data into a vowel target table (discussed below). Following task 174, target customization process 158 exits.

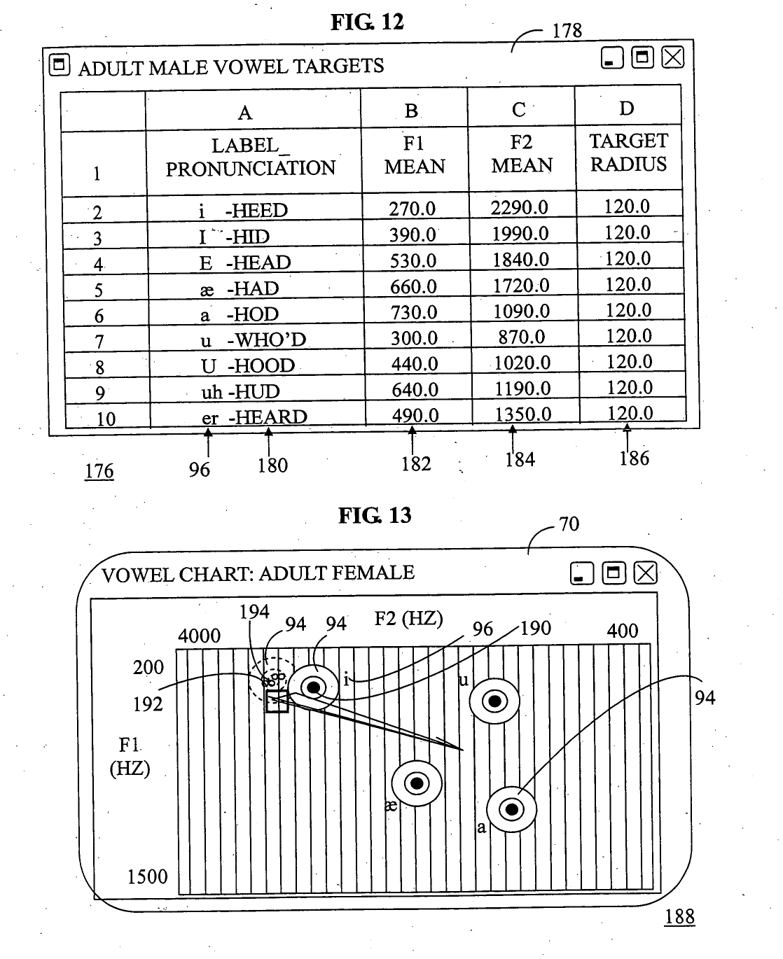

FIG. 12 shows a screen shot image 176 of a vowel target table 178 modifiable through the execution of target customization process 158 (FIG. 11). Alternatively, vowel target table 178 can be modified using parameters determined by means other than target customization process 158. Vowel target table 178 is presented to the user when the user selects one of EDIT ADULT MALE TARGETS, EDIT ADULT FEMALE TARGETS, or EDIT CHILD TARGETS from AGE/GENDER drop-down menu 86 of OPTIONS menu 82. In this particular instance, vowel target table 178 includes vowel targets for an adult male.

Vowel target table 178 includes a number of vowel sounds 96, each of which is followed by a pronunciation guide 180. Each of vowel sounds 96 has associated therewith a first average 182 of first formants 136, a second average 184 of second formants 138, and a target radius value 186. Any of first and second averages 182 and 184, respectively, and target radius value 186 can be modified at the therapist's discretion.

First and second averages 182 and 184, respectively, and target radius value 186 can be entered into various cells of vowel target table 178 similar to entry of values into a conventional spreadsheet program. First and second averages 182 and 184 of first and second formants 136 and 138, respectively, can be those obtained through the execution of target customization process 158 (FIG. 11). While target radius value 186 may be sized according to a minimum of two standard deviation values for first and second formants 136 and 138. After data in vowel target table 178 has been manipulated, it may be saved for recall at a later date.

FIG. 13 shows a screen shot image 188 of vowel chart 70 in which one of vowel targets 94 is being modified. This modification can be made in response to execution of target customization process 158, or based upon the therapist's experiences with a particular learner. Vowel target 94 for vowel sound 96 labeled /i/ is shown in an initial position 190. Small circles 192 are drawn in vowel chart 70 representing an intersection of the average first formant and second formant for each voiced segment 155 (FIG. 10) of speech signal 35.

In this exemplary scenario, learner 30 (FIG. 2) may be pronouncing vowel sound 96 labeled /i/ clearly and consistently even though the learner's pronunciations are not in accordance with vowel target 94. Consequently, average values for first and second formants that are related to small circles 192 may be computed and entered into vowel target table 178 (FIG. 12). Accordingly, vowel target 94, shown in ghost form, may be redrawn at a second position 194. In this manner, vowel targets 94 in vowel chart 70 can be customized for an individual learner. Additionally, vowel targets 94 can be customized in accordance with speech characteristics of a gender group, age group, and/or for a particular dialect group in which learner 30 is included.

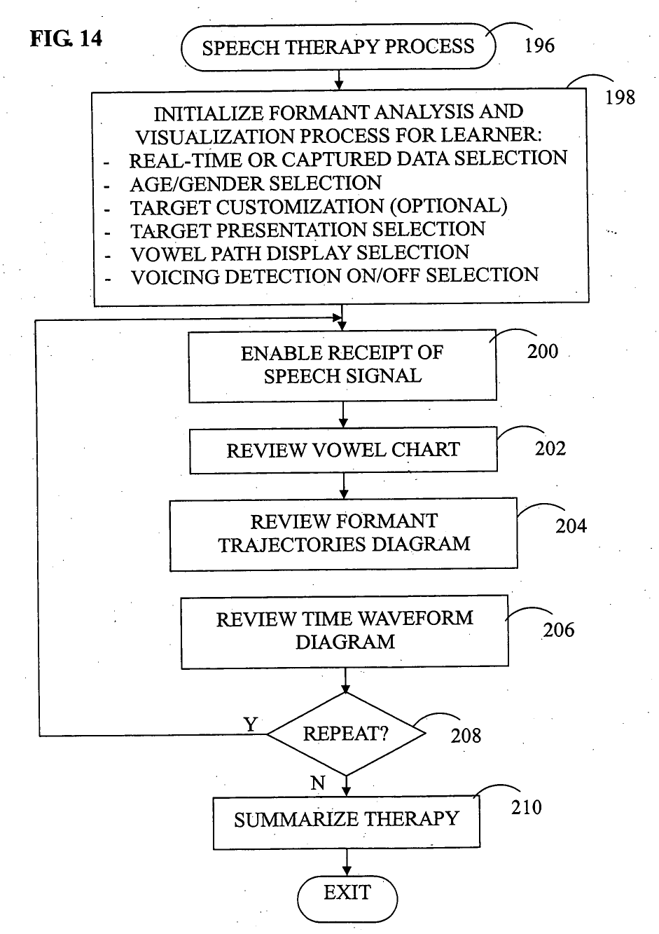

FIG. 14 shows a flowchart of a speech therapy process 196 that utilizes computing system 26 (FIG. 2) executing formant analysis and visualization process 28 (FIG. 3). Process 196 describes a generalized procedure for providing speech therapy to learner 30 (FIG. 2) or in new language sound learning using formant analysis and visualization process 28. However, the particular activities carried out by a speech therapist or teacher guiding the learning is likely to be individualized for particular learners, and for a particular learning experience.

Process 196 begins with a task 198. At task 198, formant analysis and visualization process 28 (FIG. 3) is initialized for learner 30 (FIG. 2). As discussed above, initialization may entail real-time or captured data selection, age/gender selection, target customization, target presentation selection, vowel path display selection, voicing detection, and so forth.

Following task 198, a task 200 is performed. At task 200, the user enables receipt of speech signal 35 (FIG. 2) by selecting START button 52 (FIG. 4) of main window 50 (FIG. 4). Speech signal 35 is captured and analyzed in accordance with formant analysis and visualization process 28.

Next tasks 202, 204, and 206 may be performed. At task 202, VOWEL CHART button 68 (FIG. 4) of main window 50 may be selected so that vowel chart 70 (FIG. 9) can be reviewed by the user, i.e., learner 30 and/or the speech therapist. Similarly, at task 204, FORMANT TRAJECTORIES button 72 (FIG. 4) of main window 50 may be selected so that formant trajectories diagram 74 (FIG. 10) can be reviewed, and at task 206, TIME WAVEFORM button 76 (FIG. 4) of main window 50 may be selected so that time waveform diagram 78 (FIG. 8) can be reviewed. The amount of review is determined by the user, and is likely a function of the cognitive capabilities of learner 30 to understand the displays presented to him or her. Of greatest importance, however, is vowel chart 70. Even young or cognitively impaired learners may be intrigued at trying to pronounce particular vowel sounds 96 (FIG. 6) with sufficient accuracy to match the corresponding vowel targets.

Following review tasks 202, 204, and 206, a query task 208 determines whether the process is to be repeated for another speech signal 35 (FIG. 2). When the user wishes to continue, process 196 loops back to task 200 to enable receipt of another speech signal 35. However, when a particular session of speech therapy is complete, speech therapy process 196 proceeds to a task 210.

At task 210, speech therapy activities are summarized. A summarization of therapy can take on a great number of forms, such as saving and/or printing out vowel chart 70, formant trajectories diagram 74, and/or time waveform diagram 78. In addition, summarization can take the form of discussions between the therapist and learner 30, and/or a written discussion of the learner's progress.

Referring briefly to FIG. 9, through speech therapy process 196, assistance in efforts to reach desired tongue postures is provided utilizing computing system 26 (FIG. 2) executing formant visualization and analysis process 28 (FIG. 3)). The current tongue position within the oral space during a particular vowel pronunciation is derived from an Fl/F2 formant frequency analysis. The location of a particular vowel pronunciation within vowel chart 70 is then represented as a small-square (i.e., data element 134) which may or may not be at the same point as vowel target 94 derived from the utterance of that vowel by speakers in a normative population. If the difference is too great, for example, greater than two standard deviations from vowel target 94, representing the normative mean, the particular vowel pronunciation is deemed abnormal and learner 30 (FIG. 1) or a designated speech instructor may wish to have it corrected, or normalized, through remediation (i.e., correction and repetition).

The remedial procedure of speech therapy process 196 starts with repeating the vowel, identifying the tongue location revealed by the small square (i.e., data element 134) placement within vowel chart 70, identification of the normative position of that vowel in vowel chart 70, and establishing this normative position as vowel target 94 toward which learner 30 needs to move his or her tongue. As movement is initiated and progresses toward the vowel target 94, a series of dots (data elements 142, 144, 146) can be generated that follow the movement pathway and leave trace 140 as learner 30 moves his or her tongue toward the designated vowel target 94. Learner 30 can thus visualize how tongue movement is progressing and make adjustments as needed to move the tongue/pronunciation toward vowel target 94 within vowel chart 70.

In a learning environment, an instructor can call attention to the present location of the small square (i.e., data element 134) for learner 30 within the vowel space, i.e. within the vowel diagram (vowel chart 70), and identify where they should be, using up-down, front-back descriptors on the diagram to reference desired target location for tongue and indicate that line of dots will be printed on screen to show direction of movements toward that location. The instructor then signals learner 30 to start moving tongue and use dot-line feedback to guide adjustments needed to verify straight-line tongue movement toward targeted location. The instructor further signals learner 30 to stop movement when dot line reaches vowel diagram (vowel chart 70) boundary line, hold it there, and evaluate closeness to target and, if close, how that tongue placement feels. This procedure can be replicated until tongue arrives at or near targeted location repeatedly and learner 30 can maintain this location for instructor specified time period.

Learning a new vowel may be achieved by having learner 30 place his or her tongue where he or she thinks it should be to make the desired vowel then initiating movement toward a targeted point for that vowel depicted in the quadrilateral vowel chart 70. The movement pathway, trace 140, followed to reach that point is again traced by a series of dots. The line of dots can then be used to help guide the vowel utterance toward the phonetically designated vowel target 94 in vowel chart 70.

By way of example, the /i/ is extremely difficult for deaf persons to master because it must be produced with the tongue in a high, forward position in the mouth. Tongue placement location and actions during the /i/ are concealed behind the lips and are not viewable. The tongue position within the oral space during production of the /i/ can, however, be readily discerned from its location within vowel chart 70. The procedure described above for vowel remediation can thus be repeated to establish the standard, normal /i/ vowel production. The learning experience from the /i/ can then be used to extend those vowel production skills to form words, phrases, and sentences. Feedback using vowel chart 70 thus becomes a valuable aid in establishing normal tongue postures and movements within oral space.

As briefly mentioned above, vowel diphthongs are particularly difficult for those who are deaf to master because they require blending two consecutive contrasting vowels smoothly together, as in “I”. In this instance, tongue movement starts with /a/ that is located at the low right corner of vowel chart 70 then progresses diagonally to the /i/ at the upper left corner of the quadrilateral display of vowel chart 70. The execution of this maneuver is aided through the execution of formant visualization and analysis process 28 by the generation of a set of trace line dots that follow the movement. For example, learner 30 (FIG. 1) may be instructed to follow a straight line movement pathway as the tongue is moved from the /a/ toward the targeted /i/ posture. In contrast, the (/i/ to /u/) route, as in “you”, has two sources of guidance. The movement starts at the /i/, then progresses toward the /u/ following the upper line which bounds vowel chart 70. The trace 140 that follows this action can then be used to help verify and maintain the desired straight line movement pathway.

It may be evident that movement uncertainty or motor control deficiencies may be revealed by deviations from the desired straight line movement pathway. The quadrilateral dimensions of vowel chart 70 are readily expanded and thereby enable closer scrutiny of the deviations from the straight-line, point-to-point movement pathways. The degree and patterns of these deviations can then be used as valuable diagnostic-cues pointing to or verifying possible neurological or other sources of oral motor control disturbances and/or disorders influencing the movement perception and pathways followed.

Foreign language learners substitute their own sounds for those in the new language they are striving to learn. For example, Spanish speakers learning English as a second language typically substitute /I/, as in “hid”, for the English /i/, as in “heed”. Such difficulties arise from an inability to discern auditory difference between the near neighbor /I/ vowels spoken in their native language and the /i/ as it is produced in the English language. These differences can be revealed-when the vowel Fl/F2 formant resonances are contrasted on vowel chart 70 to facilitate new language sound learning.

In summary, the present invention teaches of a method of providing speech therapy to assist those with difficulty in verbal communication that utilizes executable code operable on a conventional computing system. The executable code is in the form of a formant analysis and visualization process that generates a vowel chart. The vowel chart offers visual feedback to the user regarding the accuracy of the sound they are currently producing relative to a target characterizing an ideal pronunciation of the vowel sound. The formant analysis and visualization process enhances the learning of voiced speech, and in particular with articulating vowel sounds. Since the executable code, i.e., the formant analysis and visualization process, can be run on a conventional computing system, it is readily portable for a learner's independent study. Additional independent study enables systematic training through multiple repetitions, thereby greatly augmenting the overall learning experience.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A method for providing speech therapy to a learner comprising:
receiving a speech signal from said learner at an audio input of a computing system;
estimating, at said computing system, a first formant and a second formant of said speech signal;
presenting a target incorporated into a chart on a display of said computing system, said target characterizing an ideal pronunciation of said speech signal;
displaying a data element of a relationship between said first formant and said second formant incorporated into said chart on said display; and
comparing said data element with said target to visualize an accuracy of said speech signal relative to said ideal pronunciation of said speech signal.

2. A method as claimed in claim 1 wherein said estimating occurs in real-time in conjunction with said receiving operation.

3. A method as claimed in claim 1 wherein said estimating operation comprises utilizing an inverse-filter control algorithm for estimating said first and second formants.

4. A method as claimed in claim 1 wherein said speech signal is a first speech signal, said data element is a first data element, and said method further comprises:
estimating, at said computing system, said first formant and said second formant of a second speech signal;
displaying a second data element of a relationship between said first and second formants of said second speech signal incorporated into said chart; and
comparing said second data element with said target to visualize said second speech signal relative to said ideal pronunciation.

5. A method as claimed in claim 4 further comprising concurrently displaying said first and second data elements within said chart.

6. A method as claimed in claim 5 further comprising forming a trace within said chart interconnecting said first and second data elements.

7. A method as claimed in claim 1 wherein said chart comprises a two dimensional coordinate graph, and:
said displaying operation comprises plotting said data element as an x-y pair of said first and said second formants in said two dimensional coordinate graph; and
said presenting operation comprises plotting said target in said two dimensional coordinate graph.

8. A method as claimed in claim 7 wherein said displaying operation further comprises:
positioning said first formant as an ordinate of said x-y pair in said two dimensional coordinate graph; and
positioning said second formant as an abscissa of said x-y pair in said two dimensional coordinate graph.

9. A method as claimed in claim 7 further comprising:
arranging a first number scale along an x-axis of said two dimensional coordinate graph in descending order from leftward to rightward; and
arranging a second number scale along a y-axis of said two dimensional coordinate graph in ascending order from upward to downward.

10. A method as claimed in claim 7 wherein said presenting operation comprises characterizing said target by at least a pair of concentric circles centered at a pre-determined location in said two dimensional coordinate graph.

11. A method as claimed in claim 1 further comprising:
detecting one of a voiced sound and an unvoiced sound in said speech signal; and
disregarding said first and second formants when said speech signal is said unvoiced sound.

12. A method as claimed in claim 1 wherein:
said speech signal includes a selected vowel sound;
said presenting operation presents a plurality of targets, one each of said targets representing one each of a plurality of vowel sounds, said target being one of said plurality of targets; and
said comparing operation comprises assessing an accuracy of said selected vowel sound relative to said plurality of targets.

13. A method as claimed in claim 1 wherein said speech signal includes a selected vowel sound, and said method further comprises:
receiving a plurality of speech signals, each of said speech signals including said selected vowel sound;
repeating said estimating operation for said each of said speech signals to obtain a plurality of first formants and a plurality of second formants corresponding to said selected vowel sound;
computing a first average of said first formants;
computing a second average of said second formants; and
determining a location of said target within said chart in accordance with said first and second averages of said first and second formants.

14. A method as claimed in claim 1 further comprising determining a location of said target within said chart in accordance with a speech characteristic of said learner.

15. A method as claimed in claim 1 further comprising determining a location of said target within said chart in accordance with a speech characteristic of a population in which said learner is included.

16. A computer-readable storage medium containing executable code for instructing a processor to analyze a speech signal produced by a learner, said processor being in communication with an audio input and a display, and said executable code instructing said processor to perform operations comprising:
enabling receipt of said speech signal from said audio input;
estimating a first formant and a second formant of said speech signal in real-time in conjunction with said receiving operation;
presenting a target on said display characterizing an ideal pronunciation of said speech signal by incorporating said target into a two dimensional coordinate graph; and
displaying a data element of a relationship between said first formant and said second formant by plotting said data element as an x-y pair of said first and said second formants in said two dimensional coordinate graph for comparison of said data element with said target to visualize an accuracy of said speech signal relative to said ideal pronunciation of said speech signal.

17. A computer-readable storage medium as claimed in claim 16 wherein said speech signal is a first speech signal, said data element is a first data element, and said executable code instructs said processor to perform further operations comprising:
enabling receipt of a second speech signal from said audio input;
estimating said first formant and said second formant of said second speech signal;
displaying, concurrent with said first data element, a second data element of a relationship between said first and second formants of said second speech signal on said display as a second x-y pair in said two dimensional coordinate graph to visualize said second speech signal relative to said ideal pronunciation and said first data element.

18. A computer-readable storage medium as claimed in claim 17 wherein said executable code instructs said processor to perform a further operation comprising forming a trace on said display interconnecting said first and second data elements.

19. A computer-readable storage medium as claimed in claim 16 wherein said executable code instructs said processor to perform a further operation comprising characterizing said target by at least a pair of concentric circles centered at a pre-determined location in said two dimensional coordinate graph.

20. A computer-readable storage medium as claimed in claim 16 wherein said executable code instructs said processor to perform further operations comprising:
arranging a first number scale along an x-axis of said two dimensional coordinate graph in descending order from leftward to rightward;
arranging a second number scale along a y-axis of said two dimensional coordinate graph in ascending order from upward to downward;
positioning said first formant as an ordinate of said x-y pair in said two dimensional coordinate graph; and
positioning said second formant as an abscissa of said x-y pair in said two dimensional coordinate graph for correlation of a location of said x-y pair with a cardinal vowel diagram.

21. A computer-readable storage medium as claimed in claim 16 wherein said speech signal includes a selected vowel sound, and said executable code instructs said processor to perform further operations comprising:
enabling receipt of a plurality of speech signals, each of said speech signals including said selected vowel sound;
repeating said estimating operation for said each of said speech signals to obtain a plurality of first formants and a plurality of second formants corresponding to said selected vowel sound;
computing a-first average of said first formants;
computing a second average of said second formants; and
determining a location of said target within said chart in accordance with said first and second averages of said first and second formants.

22. A method for providing speech therapy to a learner comprising:
receiving a speech signal from said learner at an audio input of a computing system;
estimating, at said computing system, a first formant and a second formant of said speech signal in real-time in conjunction with said receiving operation;
presenting a plurality of targets incorporated into a chart on a display of said computing system, one each of said targets representing one each of a plurality of vowel sounds, and said one each of said targets characterizing an ideal pronunciation of said one each of said plurality of vowel sounds;
displaying a data element of a relationship between said first formant and said second formant incorporated into said chart; and.
comparing said data element with a selected one of said targets to visualize an accuracy of said speech signal relative to said ideal pronunciation of a selected one of said plurality of vowel sounds represented by said selected one of said targets.

23. A method as claimed in claim 22 wherein said data element is a first data element, and said method further comprises:
repeating said receiving and estimating operations for a second speech signal from said learner to obtain a second data element;
displaying said second data element within said chart concurrent with said first data element and said plurality of targets;
forming a trace on said display interconnecting said first and second data elements; and
comparing said second data element with said first data element and said target to visualize an adjustment of said second speech signal relative to said ideal pronunciation.
